(19) United States
(12) Patent Application Publication
(10) Pub. No.: US 2025/0036083 A1
(43) Pub. Date: Jan. 30, 2025

(54) TIMEPIECE REGULATING MEMBER PROVIDED WITH A HOOK ACTUATION SYSTEM

(71) Applicant: ETA SA Manufacture Horlogére Suisse, Grenchen (CH)

(72) Inventors: Julien CHRISTAN, Bienne (CH); Mohammad Hussein KAHROBAIYAN, Boudevilliers (CH); Romain LE MOAL, Villers-le-Lac (FR); Pascal WINKLER, St-Blaise (FR)

(73) Assignee: ETA SA Manufacture Horlogére Suisse, Grenchen (CH)

(21) Appl. No.: 18/761,907

(22) Filed: Jul. 2, 2024

(30) Foreign Application Priority Data
Jul. 24, 2023 (EP) 23187215.1

(51) Int. Cl. G04B 18/04; G04B 18/00

(52) U.S. Cl. CPC G04B 18/04; G04B 18/006

(57) ABSTRACT

A regulating member (1) for a horological movement, including an inertial mass, for example a balance (23), a balance spring (25) including a ribbon (2) wound in a plurality of coils, the regulating member including an actuation system for adjusting the rate of the regulating member (1), the actuation system including an actuator (30) mechanically connected to the balance spring (25), the displacement of the actuator making it possible to modify the rate of the regulating member, the actuator (30) including a hook (39) engaged with the balance spring (25), and the displacement of the actuator (30) making it possible to modify the stiffness of the balance spring (25).

### CROSS REFERENCE TO RELATED APPLICATIONS

This application claims priority to European Patent Application No. 23187215.1 filed Jul. 24, 2023, the entire contents of which are incorporated herein by reference.

### TECHNICAL FIELD OF THE INVENTION

The invention relates to the field of watchmaking, and more particularly to the field of mechanical watchmaking, where the regulation of the driving energy is provided by a regulating member.

More specifically, the invention relates to a regulating member provided with an actuation system, a horological movement comprising such a regulating member, and a timepiece comprising such a horological movement.

### Technological Background

In most mechanical watches, the energy required to rotate the hands (for example the minute and hour hands) is stored in a barrel and then delivered by a sprung balance system, which comprises a flywheel called a balance, combined with a spring in the form of a spirally wound ribbon called a balance spring.

An inside end of the balance spring is attached to a staff that rotates as one with the balance; an outside end of the balance spring is attached to a stud mounted on a stud-holder that is itself rigidly connected to a stationary bridge.

The rotation of the balance is maintained—and its oscillations counted—by an escapement mechanism comprising a pallet-lever animated by a low-amplitude oscillating motion, provided with two pallets which engage the teeth of an escape wheel. When the escape wheel is engaged in this way, it is caused to rotate in steps, the frequency of which rotation is determined by the frequency of oscillation of the pallet-lever, which is itself set to the frequency of oscillation of the sprung balance.

In a conventional escapement mechanism, the oscillation frequency is around 4 Hz, or approximately 28,800 vibrations per hour (V/h). One of the objectives of good watchmakers is to ensure the isochronism and regularity of the oscillations (or constancy of rate) of the balance.

The rate of the balance can be regulated in a known manner by adjusting the active length of the balance spring, defined as the curvilinear length between its inside end and a counting point, located in the vicinity of the outside end of the balance spring and typically defined by a pair of bankings carried by a key mounted on an index system.

In operation, this index system is not able to rotate about the axis of the balance spring. However, its angular position can be fine-tuned by manual intervention, for example by pivoting an eccentric acting like a cam on the index system using a screwdriver.

The assembly comprising the bridge, the index system, the key, the stud-holder, the stud, the staff, the spring and the balance is commonly referred to as the “regulating member”. Examples of regulating members are given in the European patent EP 2 876 504 field by the watch manufacturer ETA.

There are index systems which have a stud-holder to which one end of the balance spring is attached, and where the index system key leaves play to allow the balance spring to move between the two bankings. However, the chronometric properties, in particular the anisochronism as a function of amplitude, are very sensitive to the play of the balance spring at the index key, and this play is difficult to control precisely.

In some devices, the bankings can be adjusted to clamp the balance spring in order to eliminate play, particularly when the balance spring is in operation. In this case, first the rate is regulated by moving the index key, then clamping the balance spring to the key. However, clamping the balance spring to the index key risks stressing it and creating chronometric errors, in particular due to the off-centring of the windings. Moreover, removing the play also changes the rate, and once the balance spring has been clamped, you can no longer move the index key along the balance spring to finish fine-tuning the rate.

Other balance springs have an integrated regulating device. In these balance springs, the rate is not regulated by altering the effective length of the balance spring, but by applying a force or torque to a flexible element arranged in series with the balance spring. In this way, the stiffness of the flexible element and consequently of the balance spring as a whole, i.e. of the ribbon and of the flexible element, can be modified. Adjusting the stiffness of the balance spring allows the rate of the regulating member to be regulated. Such a balance spring provided with a flexible element is described, for example, in patent applications EP4009115 and CH0700385/2021.

In these cases, the usual systems cannot be used, as they are not compatible with the balance spring regulating device. Moreover, as the rate has to be regulated to a very fine degree, it is essential that there is no play between the balance spring and the areas where it interacts with the index mechanism. More specifically, if this were not the case, there would be a risk of the rate being altered in the event of an impact, if the balance spring does not reposition itself in exactly the same way after the impact.

To use such a balance spring, an index system has been described in patent applications EP22177059.7 and CH000678/2022. The index system comprises a stud-holder in two parts that can move relative to each other, each part being provided with a stud on which the flexible element is mounted on the one hand, and the prestressing means acting on the flexible element on the other. Thus, by moving the two parts relative to each other, the force or torque applied to the flexible element is modified, in order to adjust the stiffness of the balance spring assembly.

However, the index system is complex to implement, as the movable parts of the stud-holder each perform a rotary motion above the balance spring. Moreover, the use of two studs to suspend the balance spring and modify the rate requires the use of the two-piece stud-holder.

### SUMMARY OF THE INVENTION

The aim of the present invention is to overcome some or all of the above-mentioned drawbacks by providing a simplified actuation system compatible with this type of adjustment device.

To this end, the invention relates to a regulating member for a horological movement, comprising an inertial mass, for example a balance, a balance spring comprising a ribbon wound in a plurality of coils, the regulating member including an actuation system for adjusting the rate of the regulating member, the actuation system comprising an actuator mechanically connected to the balance spring, and the displacement of the actuator making it possible to modify the rate of the regulating member.

The invention is characterised in that the actuator includes a hook engaged with the balance spring.

The invention provides a simplified actuation system by eliminating the need to use two studs to suspend the balance spring. This makes it possible to use a one-piece stud-holder, which is easier to manufacture.

Moreover, the actuator can be positioned at a distance from the balance spring, with only the hook connected to the balance spring.

According to a particular embodiment of the invention, the balance spring comprises means for adjusting the stiffness of the balance spring, the adjustment means being provided with a flexible element arranged in series with the wound ribbon, the adjustment means comprising prestressing means for applying a variable force or torque to the flexible element in order to change the stiffness of the flexible element to adjust the rate of the regulating member, the actuator being mechanically connected to the prestressing means.

According to a particular embodiment of the invention, the prestressing means include a lever connected to the flexible element, actuation of the lever allowing the variable force or torque applied to the flexible element to be varied.

According to a particular embodiment of the invention, the hook is engaged with the lever so as to be able to displace it when actuated.

According to a particular embodiment of the invention, the lever is movable in the hook, so that it can slide when the lever performs an angular displacement.

According to a particular embodiment of the invention, the hook surrounds the lever to form a closed contour.

According to a particular embodiment of the invention, the actuator is configured to perform at least in part a substantially linear, preferably rectilinear, displacement, in order to actuate the prestressing means.

According to a particular embodiment of the invention, the actuator is eccentric relative to the regulating member, and is preferably mounted at a distance from the centre of the regulating member.

According to a particular embodiment of the invention, the actuator comprises a part that is stationary relative to the balance bridge, a spring part and a part that is movable thanks to the spring part, the movable part comprising the hook.

According to a particular embodiment of the invention, the movable part can move orthogonally to the direction of the lever.

According to a particular embodiment of the invention, the regulating member comprises a stud-holder mechanically connected to the flexible element, the stud-holder including a stud on which the flexible element is mounted.

According to a particular embodiment of the invention, the stud-holder can rotate relative to the balance bridge, so that the beat of the regulating member can be regulated.

The invention further relates to a horological movement comprising such a regulating member.

The invention further relates to a timepiece, for example a watch, comprising such a horological movement.

### BRIEF DESCRIPTION OF THE FIGURES

The aims, advantages and features of the present invention will become apparent from the detailed description of several embodiments given solely by way of non-limiting examples, with reference to the accompanying drawings in which:

FIG. 1 diagrammatically shows a perspective view of a regulating member including an actuator provided with a hook according to one embodiment of the invention, the regulating member being arranged in a horological movement,

FIG. 2 diagrammatically shows a perspective view of part of the regulating member shown in FIG. 1, without the balance bridge,

FIG. 3 diagrammatically shows a top view of part of the regulating member shown in FIG. 1, without the balance bridge, without the stud-holder and without the bearing,

FIG. 4 diagrammatically shows a top view of a balance spring of the regulating member shown in FIG. 1,

FIG. 5 diagrammatically shows a side view of the actuator of the actuation system of the regulating member in FIG. 1,

FIG. 6 diagrammatically shows a side view of the actuator in FIG. 5 mounted on the balance bridge,

FIG. 7 diagrammatically shows a perspective view of the actuator and the control lever of the regulating member,

FIG. 8 diagrammatically shows a bottom view of the regulating member in FIG. 1,

FIG. 9 diagrammatically shows a perspective view of the actuator and of the control lever of the regulating member in a first position, and

FIG. 10 diagrammatically shows a perspective view of the actuator and of the control lever of the regulating member in a second position.

### DETAILED DESCRIPTION OF THE INVENTION

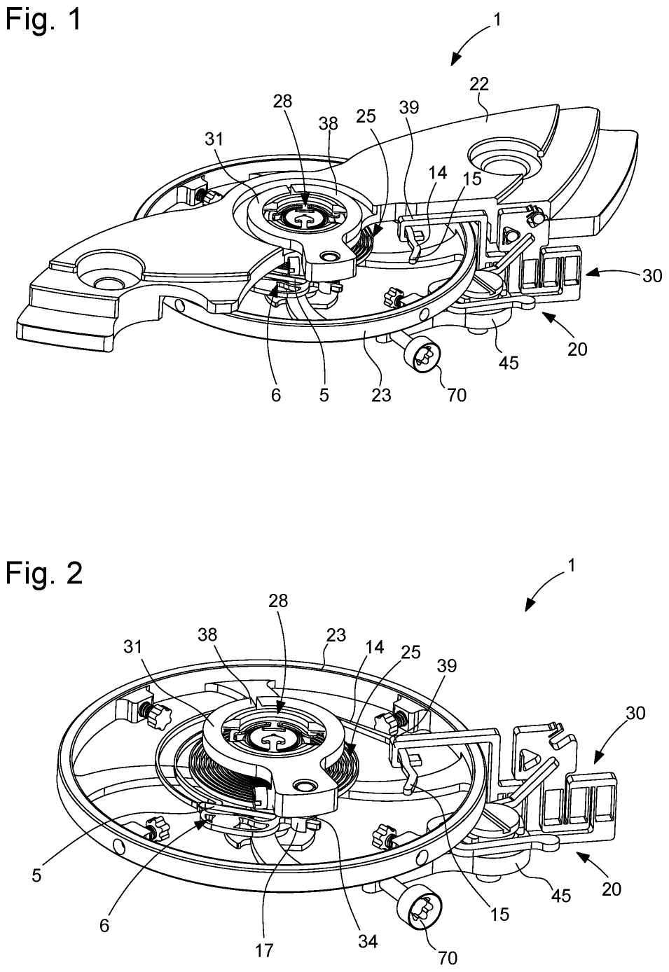

FIGS. 1 to 3 diagrammatically show one embodiment of a regulating member 1 intended to be arranged in a horological movement comprising a plate (not shown in the figures) provided with a recess. Such a movement is, for example, arranged in a timepiece, such as a watch.

The regulating member 1 comprises an inertial mass, in this case an annular balance 23, a balance spring 25 as an elastic return element for the inertial mass configured to cause it to oscillate, a balance staff 24, and a balance bridge 22. The elements are stacked from bottom to top in the following order: the balance 23, the balance spring 25 and the balance bridge 22.

The balance staff 24 passes through the centre of the balance, the balance spring 25 and the balance bridge 22. The balance staff 24 is held by two shock-absorbing bearings 28 arranged at both ends of the balance staff 24. A first bearing is arranged below the balance bridge 22, and the second bearing 28 is arranged therein. The balance bridge 22 has a through-hole inside which the second bearing 28 is held.

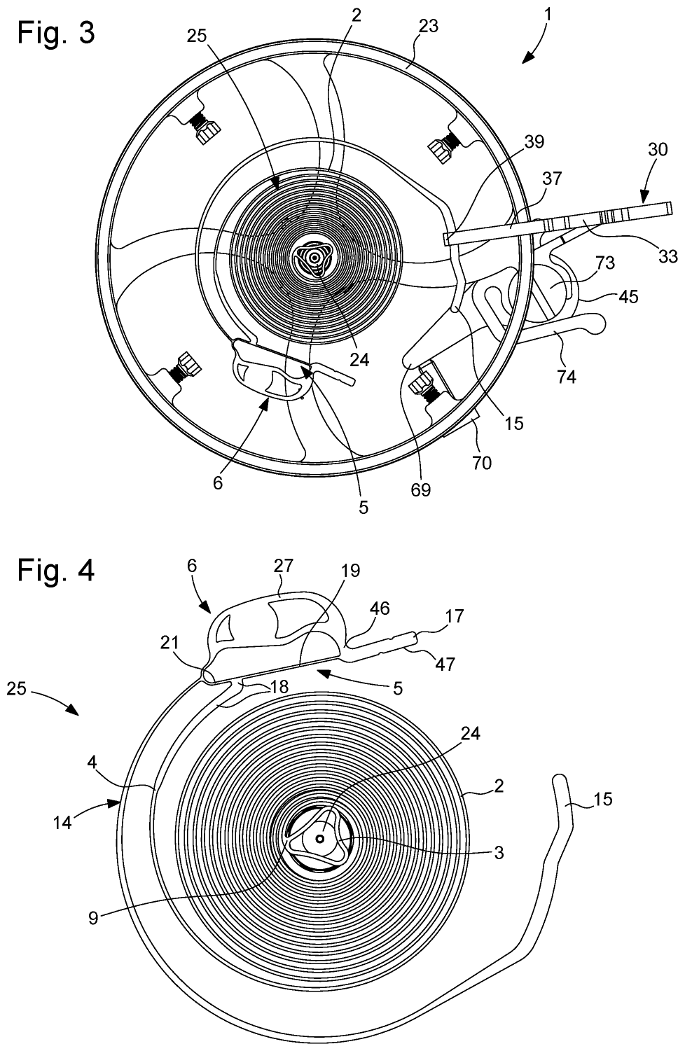

Shown in FIGS. 3 and 4, the balance spring 25 preferably extends substantially in one plane. The balance spring 25 comprises a flexible ribbon 2 wound about itself in several turns, the ribbon 2 having a predefined stiffness. The inside end 9 of the ribbon 2 is integral with or assembled with a rigid support 3, typically referred to as a collet. The rigid support 3 is substantially triangular in shape and is threaded around the staff of the balance 24.

The balance spring 25 further includes means for adjusting its stiffness. For example, the adjustment means can in particular be actuated by a user when the regulating member is mounted in the plate of the horological movement.

The adjustment means include a flexible element 5 arranged in series with the ribbon 2, with the flexible element 5 connecting an outside end 4 of said ribbon 2 to a rigid support 17. The flexible element 5 is integral with the outside end 4 of the ribbon 2. The flexible element 5 is a different element from the ribbon 2.

The flexible element 5 adds additional stiffness to that of the ribbon 2, i.e. following on from the ribbon, preferably as an extension thereof. The flexible element 5 is preferably stiffer than the ribbon 2. In this case, the flexible element 5 is arranged as an extension of the ribbon 2. Preferably, the adjustment means and the ribbon 2 are in one piece, or even made of the same material, for example silicon.

The flexible element 5 of the balance spring 25 comprises a first flexible blade 19 and a movable semi-rigid part 18, which extends from the outside end of the ribbon 2, and is connected to the first flexible blade 19, preferably on the same side of the rigid part 18. The first flexible blade 19 is also connected to the rigid support 17.

The rigid support 17 is L-shaped, with a first leg 46 of the L serving as a connection to the first flexible blade 19, and the second leg 47 of the L facing away from the first flexible blade 19 so that it can be assembled to the horological movement.

The means for adjusting the balance spring 25 further include prestressing means 6 for applying a variable force or torque to the flexible element 5. In this way, the stiffness of the balance spring can be adjusted. The torque or force is continuously adjustable thanks to the prestressing means 6. In other words, the torque or force is not restricted to isolated values. The stiffness of the flexible element 5 can thus be adjusted with great precision.

The prestressing means 6 include a secondary flexible blade 21, arranged on an opposite side of the rigid part 18 in the extension of the first flexible blade 19.

The other end of the secondary flexible blade 21 is connected to a curved lever 14 which runs around the ribbon 2. The lever 14 is connected, in addition to the secondary flexible blade 21, to a semi-rigid structure 27 attached to the rigid support 17. The semi-rigid structure 27 deforms in part when the lever 14 is actuated by the force or torque.

The force or torque is exerted on the free end 15 of the lever 14. In this way, the lever 14 of the prestressing means 6 transmits the force or torque to the flexible element 5 via the secondary flexible blade 21 and the semi-rigid structure 27, so as to modify the stiffness of the balance spring 25.

In order to be able to apply the variable force or torque to the balance spring 25, the regulating member comprises a specific actuation system 20.

In the embodiment shown in FIGS. 1 to 3, the regulating member 1 comprises a stud-holder 31 provided with a suspended stud 34. The stud-holder 31 is mechanically connected to the flexible element 5, but does not block the ribbon 2. The stud-holder 31 surrounds the second bearing 28. For this purpose, the stud-holder 31 comprises a central ring 38 arranged around the second bearing 28, and which rests on the balance bridge 22.

The stud 34 cooperates with the second leg 47 of the rigid support 17. In this way, the prestressing means 6 and the flexible element 5 are supported by the stud-holder 31 from which they are suspended.

Moreover, the stud 34 is rigidly attached to the rigid support 17. In other words, the stud 34 is integral with the rigid support 17. The stud 34 and the balance spring 25 are assembled, for example, by bonding, brazing, welding, by deformation of metallic glass, or by mechanical fastening.

The stud 34 can move relative to the balance bridge. To this end, the stud-holder 31 can rotate about the second bearing 28 relative to the balance bridge 22. The stud-holder 34 can, for example, be displaced over an angular range of 20° or even 10°.

By displacing the stud 34 relative to the balance bridge 22, the beat of the regulating member 1 can be regulated.

The actuation system 20 further comprises an actuator 30 configured to actuate the lever 14. The actuator 30 is mechanically connected to the prestressing means 6, the actuator 30 being configured to perform at least in part a substantially linear, preferably rectilinear, displacement, in order to actuate the prestressing means 6.

In other words, at least part of the actuator 30 moves substantially along a straight line, unlike, for example, the stud-holder 31 which undergoes rotation by turning about an axis. In this way, at least part of the actuator 30 moves towards or away from the balance spring 25 in a direction oriented substantially towards the balance spring.

Preferably, the direction of displacement of the actuator 30 is substantially radial with respect to the balance 23 and the balance spring 25. In this way, the straight line along which the actuator 30 moves is directed towards the centre of the balance 23 and the balance spring 25. This also makes the rate setting independent of the beat setting.

The actuator 30 is off-centred with respect to the regulating member, i.e. it is mounted at a distance from the centre of the regulating member 1, and is connected only to the lever 14 of the adjustment means. The actuator 30 is therefore not mounted directly on the regulating member 1, like a stud-holder on a bearing 28 of the regulating member 1, for example.

In this embodiment, the actuator 30 is mounted on the balance bridge 22. Preferably, the actuator 30 is mounted on the plate substantially perpendicular to the plane of the balance bridge 22. More specifically, it is assembled on an edge of the balance bridge 22.

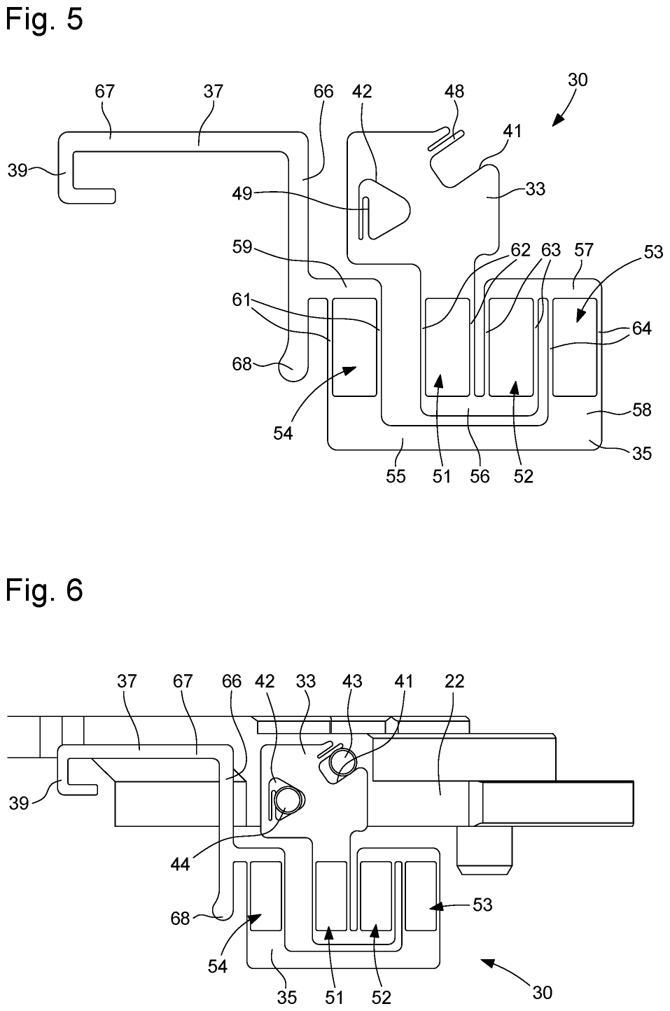

In FIGS. 5 and 6, the actuator 30 comprises in particular a stationary part 33 mounted on the balance bridge 22, a part 37 movable relative to the balance bridge 22 and connected to the lever 14, and a spring part 35, formed by a flexible guide, joining the movable part 37 to the stationary part 33. The stationary part 33 and the movable part 37 are preferably rigid. The stationary part 33, the spring part 35 and the movable part 37 are arranged in the same plane. The actuator 30 is therefore generally flat and extends substantially in one plane.

According to the invention, to actuate the lever 14, the actuator 30 comprises a hook 39 engaged with the lever 14, the hook 39 being mounted on the movable part 37. The hook 39 at least partially surrounds the lever 14.

In an alternative embodiment, as shown in the figures, the hook 39 surrounds the lever 14 to form a closed contour. This avoids the risk of the hook 39 and the lever 14 detaching. Preferably, the contour is substantially square.

The hook 39 can further comprise a rounded part inside the hook to reduce the contact area between the hook 39 and the lever 14.

Moreover, the lever 14 can move in the hook 39, so that it can cause the lever 14 to slide, when the balance spring 25 performs an angular displacement.

A radial displacement of the movable part 37 of the actuator 30 pulls or pushes the lever 14 radially with respect to the balance spring 25. This changes the stiffness of the flexible element 5, as the displacement of the lever exerts a greater or lesser force or torque on the flexible element 5, so that the stiffness of the flexible element 5 varies, and consequently the stiffness of the balance spring 25 as a whole also varies. The actuation system 20 thus allows the rate of the regulating member 1 to be regulated.

The stationary part 33 here has a substantially square shape, and is provided with at least one attachment notch 41, preferably two attachment notches 41, 42, each for receiving a pad 43, 44 extending from the balance bridge 22. The attachment notches 41, 42 are arranged, for example, on two diagonally opposite sides of the stationary part 33.

Each notch 41, 42 is provided with a flexible tongue 48, 49 arranged in the notch 41, 42. The first notch 41 is open at the side so that it can slide laterally around the first pad 43. The second notch 42 is closed and can receive the second pad 44 by insertion into the second notch 42. The flexible tongues 48, 49 deform when a pad 43, 44 enters the notch 41, 42, and act as a means of support to retain the pad 43, 44 in the notch 41, 42. Moreover, the flexible tongues 48, 49 make it possible to improve positioning accuracy by overcoming the play in the positioning of the pads 43, 44 in the notches 41, 42, preferably in the same direction.

As shown in the figures, the actuator 30 is mounted on the balance bridge 22, so as to be substantially perpendicular to the plate and to the balance bridge 22. It is therefore mounted on the edge of the balance bridge 22.

The spring part 35 is arranged below the stationary part 33, so that it extends below the level of the balance bridge 22.

In this case, the spring part 35 includes a plurality of translation stages 51, 52, 53, 54 with flexible blades arranged in series, one after the other. They are defined as being in series because the displacements of each translation stage are at least partly cumulative.

Each translation stage 51, 52, 53, 54 comprises a pair of substantially parallel flexible blades 61, 62, 63, 64 and a rigid section 56, 57, 58, 59 on which the pair of flexible blades 61, 62, 63, 64 is mounted.

The first translation stage 51 is arranged under the stationary part 33 and has a first rigid section 56 which is lengthened in order to be associated with a second translation stage 52 arranged head-to-tail with the first translation stage 51. In this way, the second pair of flexible blades 52 is substantially parallel to the first pair of flexible blades 51. The second rigid section 57 is substantially parallel to the first rigid section 56, but is offset by half the length of the first rigid section 56.

The second rigid section 57 is also lengthened to associate a third translation stage 53 arranged head-to-tail with the second translation stage 52, and therefore substantially parallel to the first translation stage 51. The third pair of flexible blades 63 is substantially parallel to the first 61 and the second pair of flexible blades 62.

The actuator 30 comprises a fourth translation stage 54 arranged on the other side of the first translation stage 5 from the second 52 and the third translation stage 53. The fourth translation stage 54 is arranged head-to-tail with the third translation stage 53.

In this way, the fourth pair of flexible blades 64 is substantially parallel to the other pairs of flexible blades, and the fourth section 59 is arranged in substantially the same direction as the second section 57.

The third 53 and the fourth translation stage 54 are connected by an arm 55 extending from the third section 58, and passing below the first rigid section 56 of the first translation stage 51.

This arrangement of translation stages 51, 52, 53 and 54 enables the movable part 37 to be displaced in a substantially linear, preferably rectilinear, manner, while maintaining a compact actuator 30.

Preferably, the actuator 30 comprises an even number of translation stages, as two translation stages arranged head to tail enable the vertical deviation of the hook 39 generated by each to be mutually compensated for. In this way, the hook 39 remains at substantially the same height while moving.

The movable part 37 extends from the fourth section 59. The movable part 37 is preferably rigid. In this case, the movable part 37 has the shape of an elbow formed by a first segment 66 arranged perpendicular to the fourth section 59 and a second segment 67 forming a right angle with the first segment 66.

The hook 39 of the actuator 30 is located at the end of the second segment 67. At the free end of the first segment 66, a bulge 68 acts as a support for moving the movable part 37.

By pressing more or less hard on the bulge 68, the movable part 37 moves more or less closer to the stationary part 33, thanks to the deformation of the translation stages 51, 52, 53, 54 of the spring part 35.

In this way, the hook 39 pulls more or less hard on the lever 14 to actuate the means for adjusting the stiffness of the flexible element 5.

The direction of displacement of the movable part 39 of the actuator 30 and of the lever 14 is substantially orthogonal to the direction of the lever 14.

Moreover, the lever 14 is preferably movable in the hook 39, so that it can slide when the lever 14 performs an angular displacement. To this end, lever 14 comprises a free end 15 cooperating with the hook 39.

For example, in order to be able to adjust the beat of the regulating member 1, the stud-holder 31 must be able to rotate. Consequently, the balance spring 25 rotates with the stud-holder 31, and the free end 15 of the lever 14 slides in the hook 39.

Thanks to such an actuation system 20, the beat can be regulated without having to modify the position of the actuator 30, in particular with respect to the plate of the movement. The mechanical link between the actuator 30 and the lever 14 is maintained, regardless of the position of the lever 14 relative to the actuator 30.

This actuation system 20 thus enables the rate and the beat to be regulated independently of each other, while keeping a constant predetermined position of the actuator in the movement, for example in relation to the plate and the balance bridge 22.

The actuation system 20 further comprises regulating means cooperating with the actuator 30 so as to be able to displace the movable part 37 of the actuator 30.

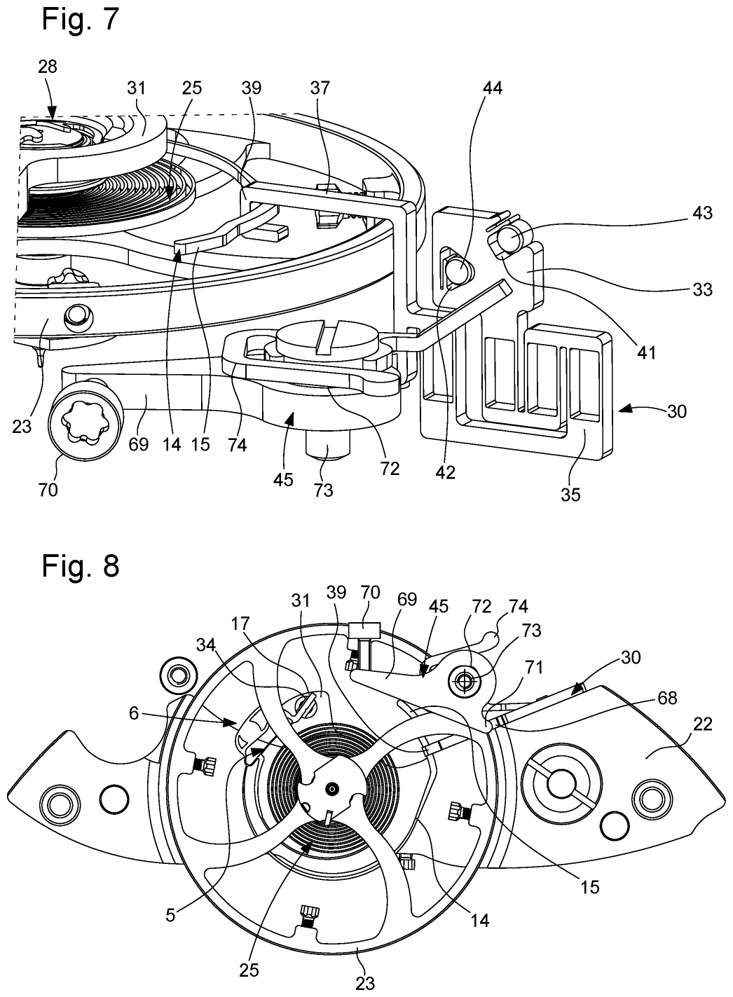

As shown in FIGS. 7 to 10, the regulating means comprise a pivoting control lever 45 arranged to displace the movable part 37 of the actuator 30. The control lever 45 is preferably arranged in a plane substantially perpendicular to the plane of the actuator 30, and is in contact with the bulge 68 of the movable part 37.

The control lever 45 has a pivot arm 69 and a support arm 71 connected to a hub 72 of the pivoting control lever 45.

The support arm 71 cooperates with the movable part 37 of the actuator 30 to displace it mechanically by contact. The support arm 71 pushes the bulge 68 of the movable part 37 to a greater or lesser extent to move it. The hook 39 thus pulls the lever 14 of the balance spring 25 to a greater or lesser extent. The control lever 45 is configured to pivot in a plane substantially perpendicular to the plane of the actuator 30.

The control lever 45 is configured to be mounted on the plate of the movement via the hub 72, which can rotate about a screw body 73, the screw 73 being mounted on the plate.

Thus, by rotating the control lever 45 about the screw body 73, the movable part 37 moves towards or away from the stationary part 33 by deforming the spring part 35 of the actuator 30 to a greater or lesser extent in order to modify the position of the lever 14.

The regulating means further include a control screw 70 mechanically connected to the pivot arm 69, in order to control the pivoting of the control lever 45. The axis of the control screw 70 is arranged in the plane of the control lever 45 in the direction of the pivot arm 69.

Thus, by screwing or unscrewing the control screw 70, the control lever 45 and the actuator 30 are actuated in order to move the hook 39 and therefore the lever 14 of the prestressing means 6.

The return force of the spring part 35 of the actuator 30 pushes the control lever 45 against the control screw 70. In this way, the pivot arm 69 of the control lever 45 is held against the control screw 70.

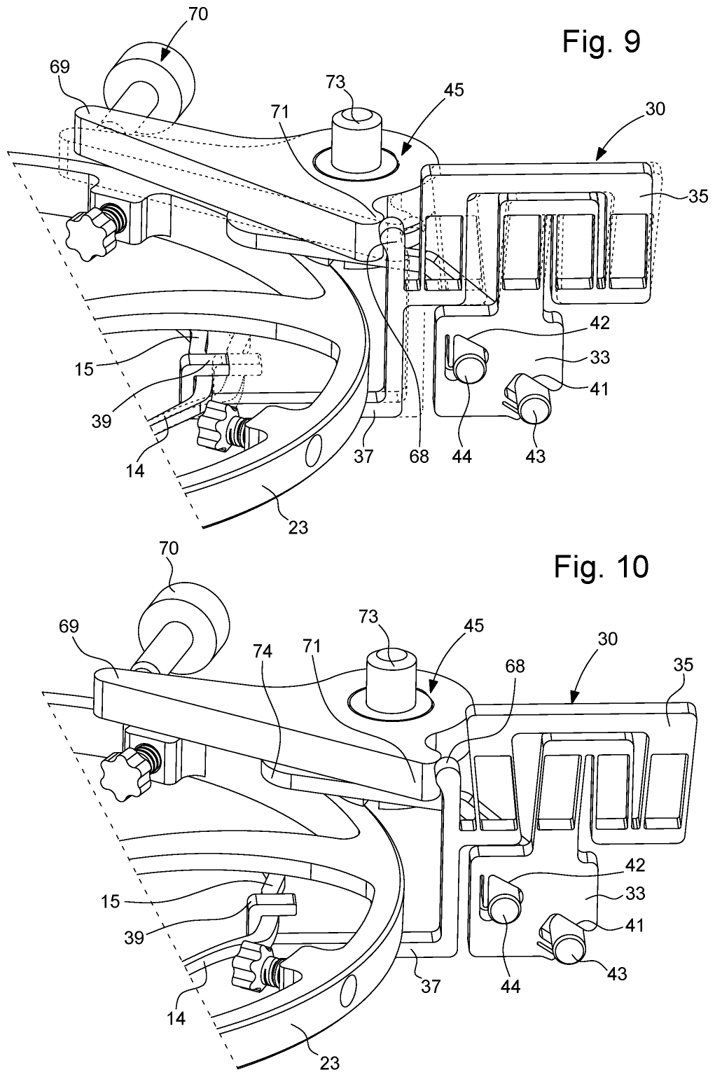

In FIG. 9, the control screw 70, the control lever 45, the movable part 37 of the actuator 30, and the lever 15 are each in a first position, in which the hook 39 pulls lightly on the lever 15. The dotted lines show the control lever 45, the movable part 37 of the actuator 30, and the lever 15 in a second position corresponding to that of FIG. 10.

In FIG. 10, the control screw 70, the control lever 45, the movable part 37 of the actuator 30, and the lever 15 are each in a second position, in which the hook 39 pulls more strongly on the lever 15 than in FIG. 9.

In the second position, the control screw 70 pushes the pivoting arm 69 of the control lever 45, so that the support arm 71 in contact with the bulge 68, in turn pushes the movable part 37 of the actuator 30 towards the stationary part 33 by deformation of the spring part 35. In this way, the hook 39 pulls on the lever 14, which performs a centrifugal displacement.

In the deformed configuration of the spring part 35, the flexible blades of the first translation stage 51 and of the third translation stage 53 deform in the same first direction, whereas the flexible blades of the second translation stage 52 and of the fourth translation stage 54 deform in the same second direction, the second direction being opposite to the first direction.

A spring 74 is arranged around the screw body 73 to press the actuator 30 against the balance bridge 22, so that it does not become detached.

The spring 74 clamps the screw body 73. The spring 74 is U-shaped and surrounds the screw body 73. One leg of the U extends in this case from the stationary part 33 of the actuator 30 to which it is attached.

It goes without saying that the invention is not limited to the embodiments of regulating members described with reference to the figures and alternatives can be considered without leaving the scope of the invention.

1. A regulating member (1) for a horological movement, comprising an inertial mass, a balance spring (25) comprising a ribbon (2) wound in a plurality of coils, the regulating member including an actuation system for adjusting the rate of the regulating member (1), the actuation system comprising an actuator (30) mechanically connected to the balance spring (25), the displacement of the actuator making it possible to modify the rate of the regulating member, wherein the actuator (30) includes a hook (39) engaged with the balance spring (25), the displacement of the actuator (30) making it possible to modify the stiffness of the balance spring (25).

2. The regulating member (1) according to claim 1, wherein the balance spring (25) comprises means for adjusting the stiffness of the balance spring (25), the adjustment means being provided with a flexible element (5) arranged in series with the wound ribbon (2), the adjustment means comprising prestressing means (6) for applying a variable force or torque to the flexible element (5) in order to change the stiffness of the flexible element (5) to adjust the rate of the regulating member (1), the actuator (30) being mechanically connected to the prestressing means (6).

3. The regulating member according to claim 2, wherein the prestressing means (6) include a lever (14) connected to the flexible element (5), actuation of the lever (14) enabling the variable force or torque applied to the flexible element (5) to be varied.

4. The regulating member according to claim 3, wherein the hook (39) is engaged with the lever (14) to allow it to be displaced when actuated.

5. The regulating member according to claim 4, wherein the lever (14) is movable in the hook (39), so that it can slide when the lever (14) performs an angular displacement.

6. The regulating member according to claim 4, wherein the hook (39) surrounds the lever (14) to form a closed contour.

7. The regulating member according to claim 1, wherein the actuator (30) is configured to perform at least in part a substantially linear, preferably rectilinear, displacement, in order to actuate the prestressing means (6).

8. The regulating member according to claim 1, wherein the actuator (30) is eccentric relative to the regulating member (1) and mounted at a distance from the centre of the regulating member (1).

9. The regulating member according to claim 1, wherein the actuator (30) comprises a part (33) that is stationary relative to the balance bridge (22), a spring part (35) and a part (37) that is movable thanks to the spring part (35), the movable part (37) comprising the hook (39).

10. The regulating member according to claim 3, wherein the movable part (37) can move orthogonally to the direction of the lever (14).

11. The regulating member according to claim 2, further comprising a stud-holder (31) mechanically connected to the flexible element (5), the stud-holder (31) including a stud (34) on which the flexible element (5) is mounted.

12. The regulating member according to claim 11, wherein the stud-holder (31) can rotate relative to the balance bridge (22) in order to regulate the beat of the regulating member (1).

13. A horological movement, comprising the regulating member (1) according to claim 1.

14. A timepiece comprising the horological movement according to claim 13.
